(19) United States
(12) Patent Application Publication
(10) Pub. No.: US 2021/0094060 A1
(43) Pub. Date: Apr. 1, 2021

(54) COATING APPARATUS

(71) Applicant: STC Chemistry, LLC, Dawson, NE (US)

(72) Inventor: Rodney R. Heinen, Dawson, MO (US)

(73) Assignee: STC Chemistry, LLC, Dawson, NE (US)

(21) Appl. No.: 16/752,402

(22) Filed: Jan. 24, 2020

Related U.S. Application Data
(63) Continuation-in-part of application No. 16/590,100, filed on Oct. 1, 2019.

(51) Int. Cl. B05C 5/02; B05D 1/00

(52) U.S. Cl. CPC B05C 5/0208; B05D 1/002

(57) ABSTRACT

Coating apparatus (20) includes a pair of juxtaposed bodies (22, 24, 112, 114, 112a, 114a, 138, 140) defining a nip region (30, 126, 126a, 150) therebetween, with each presenting a periphery (26, 28, 116, 118, 116a, 118a, 144, 146) and being rotatable in opposite directions, respectively. The peripheries (26, 28, 116, 118, 116a, 118a, 144, 146) of the bodies (22, 24, 112, 114, 112a, 114a, 138, 140) are provided with a series of indentations (32, 120, 120a, 148). Liquid coating material is directed onto the bodies (22, 24, 112, 114, 112a, 114a, 138, 140) through an outlet (100, 110, 158) during rotation of the bodies (22, 24, 112, 114, 112a, 114a, 138, 140). This generates an adjustable spray or fog flow pattern (108) for effective coating of a substrate.

### CROSS-REFERENCE TO RELATED APPLICATION

This application is a continuation-in-part of application Ser. No. 16/590,100 filed Oct. 1, 2019, which is incorporated by reference herein in its entirety.

### BACKGROUND OF THE INVENTION

### Field of the Invention

The present invention is broadly concerned with coating apparatus for various substrates and which can be used in a variety of different coating environments. More particularly, this is concerned with particular apparatus as well as methods of coating substrates making use of juxtaposed, peripherally notched cylindrical bodies cooperatively defining a nip region. Liquid coating material is directed towards the nip region during counter-rotation of the bodies, which creates an even and adjustable flow pattern of coating material to facilitate coating operations.

### Description of the Prior Art

Coating devices for particulate substrates, and especially agricultural seeds, have been available for many years. These devices are designed to coat substrates with a variety of agents, such as fungicides, insecticides, pesticides, germination controllers, or fertilizers in liquid polymeric form. Typically, these coaters include a rotating head or similar expedient for creating a spray or fog of coating material. In many cases, the coating material is ejected through a restricted orifice nozzle in order to give a desired coating pattern.

However, these prior devices are plagued by a number of intractable problems. For example, it is very difficult to uniformly coat the particulate material, owing to the fact that many coaters do not generate truly uniform flow patterns. Furthermore, restricted orifice nozzles often become partially or completely clogged, which exacerbates the problem of providing uniform coating characteristics and also can result in a complete shutdown of a coating operation.

There is accordingly a need in the art for improved coating apparatus which avoid the use of highly restricted nozzles typical of the prior art, while creating even, predictable flow patterns serving to evenly coat substrates.

### SUMMARY OF THE INVENTION

The problems outlined above are overcome by the improved coating apparatus of the present invention. Generally speaking, such apparatus comprises a pair of juxtaposed bodies each presenting a peripheral surface and oriented to cooperatively define a nip region between the peripheral surfaces, where each of the peripheral surfaces is equipped with a series of spaced apart indentations. Apparatus is provided for rotating the bodies in opposite rotational directions, respectively, at a speed generally from about 40-800 rpm. Structure is further provided for delivery of a coating liquid towards the juxtaposed bodies for passage through the nip region from one side of the bodies during rotation thereof, such that the coating liquid is ejected from the nip region after passage therethrough in a direction away from the bodies.

The bodies may be of various shapes, such as substantially cylindrical or frustoconical. The bodies may be unitary and formed of a suitable metal or synthetic resin material, such as Delrin. Alternately, the bodies may be formed of individual plate segments which are connected by through-bolts. It has been found that differently shaped bodies, and the nature of the peripheral indentations thereof, can be modified to achieve different flow patterns of coating liquid.

In certain embodiments, the indentations are substantially circular in plan configuration, and are generally conical in cross-section. These indentations may be located in respective rows extending between the ends of the bodies, and may be designed to mate with corresponding indentations on the adjacent roller body. In other forms, the indentations may be generally rectangular with sloping bottom surfaces and arranged to present a series of chevron patterns on the peripheral surfaces of the bodies.

The rotating apparatus is advantageously in the form of a motor (e.g., a variable speed motor) operatively coupled to one of said bodies, and the two bodies are in substantially frictional engagement so that the driven rotation of the one body effects counter-rotation of the other body.

In many instances, the design of the rotating bodies and the peripheral indentations thereof are used to create a diverging flow pattern of coating material from the nip region. Any suitable means can be employed for delivery of coating matter towards the rotating bodies and especially the nip region therebetween, such as a simple outlet pipe proximal to the bodies, which may be rotationally adjusted to achieve the desire flow pattern.

The invention also provides a method of applying a liquid coating material onto a substrate, comprising the steps of first directing a stream of the liquid coating material generally towards the substrate, and passing the coating material into and through a nip region defined by a pair of juxtaposed bodies each presenting a peripheral surface. The bodies are rotated in opposite directions during the liquid application step. In order to provide optimum coating characteristics, the peripheries of the cylindrical bodies are equipped with a series of spaced apart indentations of any desired shape and dimension. This causes the bodies, and especially the peripheral indentations thereof, to expel the liquid coating material from the nip region and onto the substrate. The spray pattern advantageously diverges from the nip region to create a spray or fog of liquid coating material.

### BRIEF DESCRIPTION OF THE DRAWINGS

FIG. 1 is a perspective view of coating apparatus in accordance with the invention, illustrated in a use position located above an auger conveyor;

FIG. 2 is a rear perspective view of the coating apparatus;

FIG. 3 is a plan view of the coating apparatus;

FIG. 4 is a front elevation view of the coating apparatus;

FIG. 5 is a side view of the coating apparatus;

FIG. 6 is a schematic view illustrating the rotation of the plates forming a part of the rotatable bodies of the coating apparatus, and illustrating the configuration of the peripheral rectangular indentations in the bodies;

FIG. 7 is a perspective view of one of the rotatable bodies of the coating apparatus, shown with a series of chevron patterns having particular included angles;

FIG. 8 is a perspective view similar to that of FIG. 7, but depicting the rotatable bodies with chevron patterns having different included angles as compared with FIG. 7;

FIG. 9 is an exploded perspective view of one of the rotatable bodies;

FIG. 10 is a schematic illustration of a series of plate notches forming a chevron pattern with an apex notch and a plurality of diverging notches defining respective chevron legs;

FIG. 11 is a plan view of a pair of juxtaposed rotatable coating bodies equipped with circular peripheral indentations, where the indentations are fully aligned;

FIG. 12 is a plan view of a pair of juxtaposed rotatable coating bodies equipped with circular peripheral indentations, where the indentations are offset in adjacent rows thereof;

FIG. 13 is a fragmentary sectional view taken along line 13-13 of FIG. 12 and illustrating the configuration of the circular peripheral indentations;

FIG. 14 is a top perspective view of a coating apparatus including a hexagonal housing with three pairs of coating rollers therein, wherein the rollers are of generally frustoconical configuration;

FIG. 15 is a bottom view of the coating apparatus of FIG. 14;

FIG. 16 is a vertical sectional view of the coating apparatus of FIG. 14 and illustrating the driving connection of the driven rollers of the roller pairs; and

FIG. 17 is a sectional view taken along line 17-17 of FIG. 16.

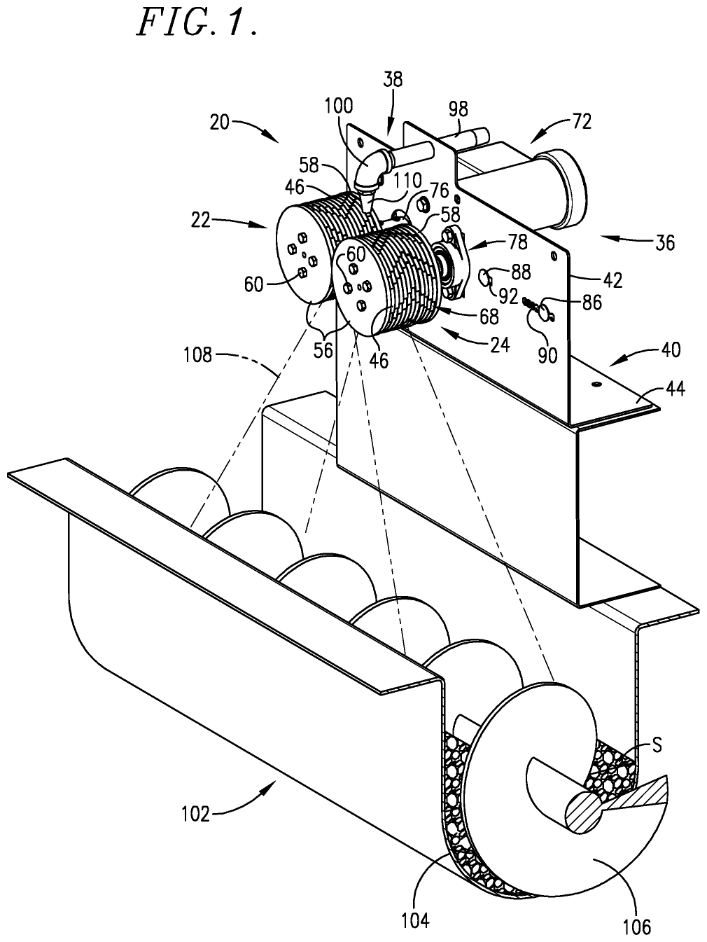

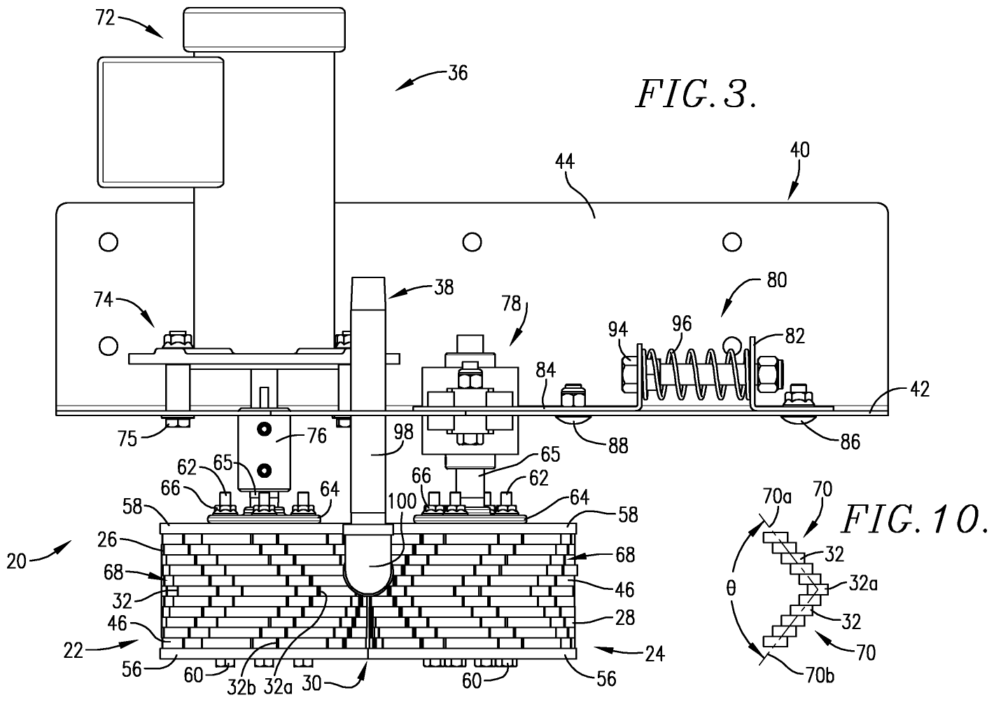

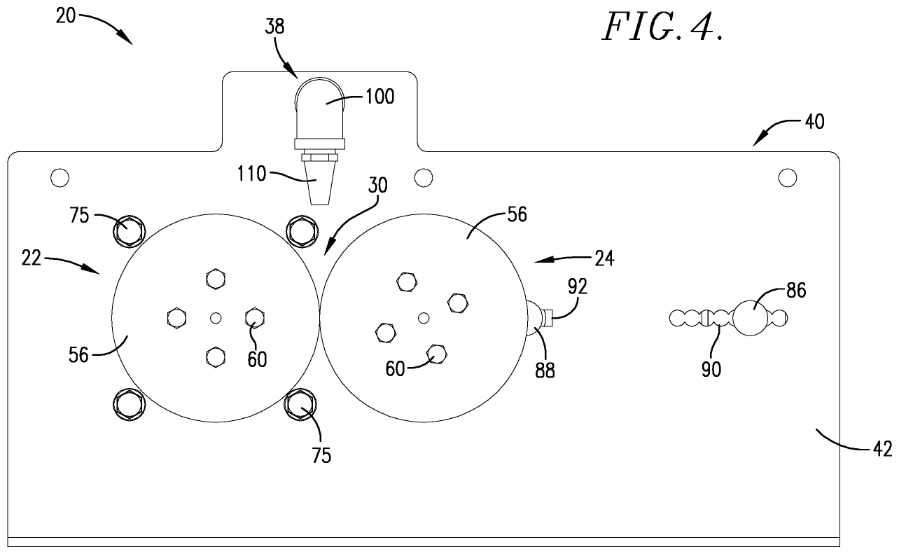

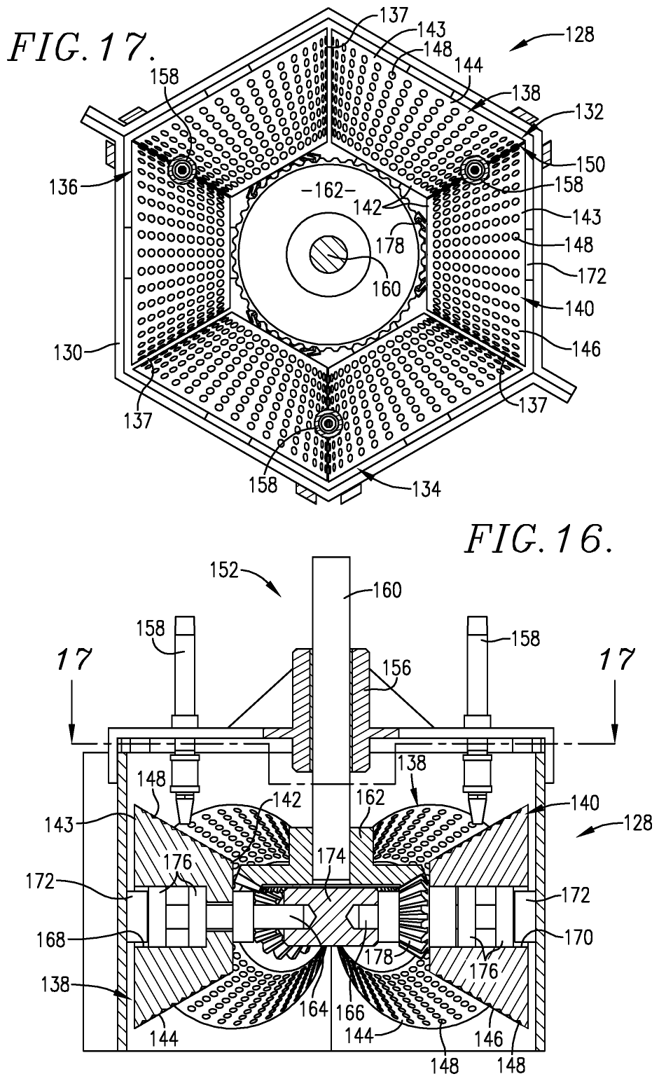

While the drawings do not necessarily provide exact dimensions or tolerances for the illustrated components or structures, FIGS. 1-17 are to scale with respect to the relationships between the components of the structures illustrated therein.

### DETAILED DESCRIPTION OF THE PREFERRED EMBODIMENTS

### Embodiment of FIGS. 1-10

Turning now to the drawings, a coating apparatus 20 in accordance with the invention broadly includes a pair of cylindrical, juxtaposed rollers or bodies 22 and 24 each presenting a peripheral surface 26 and 28 and cooperatively defining a nip region 30 between the bodies. The peripheral surfaces 26, 28 have a series of laterally spaced apart indentations or inclined notches 32 therein, which are important for reasons to be explained. In addition, the overall apparatus 20 includes drive apparatus 36 serving to rotate the bodies 22, 24 in opposite rotational directions, respectively, as well as coating liquid delivery structure 38 positioned adjacent the bodies 22, 24. In more detail, the apparatus 20 is supported on a generally L-shaped plate 40 having an upstanding wall 42 and a base 44. The body 22 is made up of a series of identical, face-to-face engaged individual plates 46. Each plate 46 has a plurality (here 8) of the circumferentially spaced apart notches 32 formed on the periphery thereof; each notch 32 has an inwardly extending wall 48 presenting a bottom edge 50, as well as an inclined wall 52 extending from the bottom edge 50 toward the periphery of the plate 46. Referring to FIG. 9, it will also be seen that each plate 46 has a series of arcuate adjustment through-slots 54 inboard of the plate periphery.

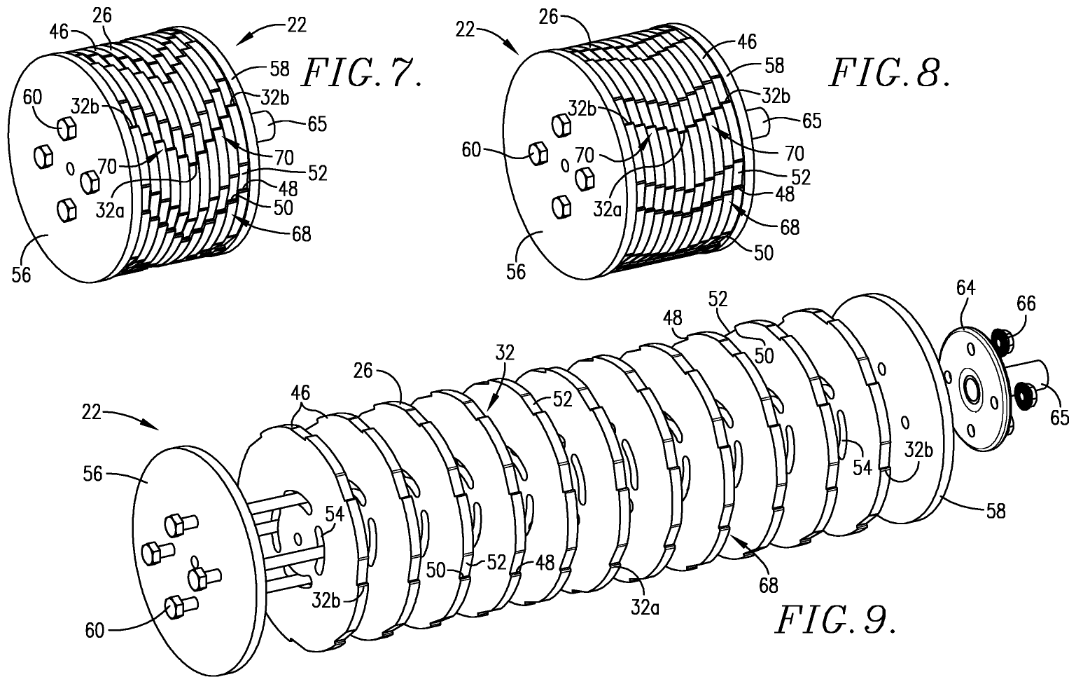

The individual plates 46 are secured together by means of a pair of endmost, smooth, unnotched drive plates 56 and 58, which have a slightly greater diameter than the plates 46. The drive plates have a series of apertures therethrough which receive elongated connection bolts 60. As illustrated, the bolts 60 extend through the adjustment slots 54 of the plates 46 and have threaded inner ends 62. The ends 62 extend through a circular drive shaft mount 64 having a rearwardly extending rotatable drive shaft 65; connection nuts 66 are used to interconnect the mount 64, drive plate 58, the several plates 46, and outer drive plate 56. As assembled, the individual plates 46 are located so that the notches 32 thereof define a series of circumferentially spaced apart chevron patterns 68, including an apex notch 32a and a staggered series of notches 32b which define diverging legs 70 extending outwardly and rearwardly from the apex notch 32a. Furthermore, the patterns 68 are arranged to that during rotation of the bodies 22, 24, the apex notches 32a are shifted toward and through the nip region 30, while the diverging legs 70 trail the apex notches 32a (see FIGS. 7-8 and 10).

Drive apparatus 36 comprises a variable speed motor assembly 72 supported on wall 42 by stand-off connection structure 74 and sleeve-covered through-bolts 75. As illustrated, the motor assembly 72 has a coupler 76 extending through wall 42 and operatively secured to the drive shaft 65 of mount 64 for rotation of the body 22.

The body 24 and mount 64 are identical with those of body 22 and thus like parts have been identically numbered. However, the drive shaft 65 of the body 24 is supported by means of a conventional bearing assembly 78 affixed to wall 42 in spaced relationship to the motor assembly 72. The bodies 22 and 24 are drivingly interconnected by means of the engaged drive plates 56 and 58 on the respective bodies. Thus, when body 22 is rotated through the medium of motor assembly 72, the body 24 is rotated in the opposite rotational direction owing to the frictional engagement between the plates 56 and 58 on each body 22, 24.

An adjustable tensioning device 80 is secured to the face of wall 42 remote from the bodies 22, 24, and includes a pair of spaced apart, apertured, L-shaped brackets 82 and 84 adjustably mounted on wall 42 by means of connectors 86 and 88; connector 86 passes through an elongated, stepped bore 90, whereas connector 88 passes through a shorter, straight slot 92. As depicted, the bracket 84 is also secured to the bearing assembly 78 supporting body 24. A bolt 94 extends through the brackets 82 and 84 and is equipped with a surrounding helical compression spring 96. Adjustment of the position of the bracket 82 is achieved by moving the connector 86 to one of the stepped positions of bore 90, which in turn increases or decreases the force exerted by spring 96 against bracket 84, which is slidable within straight slot 92. This correspondingly increases or decreases the engagement forces between the end plates 56, 58 as needed to assure an appropriate driving connection between the bodies 22 and 24.

The liquid delivery structure 36 includes an elongated pipe 98 equipped with an outlet 100 in the form of an elbow positioned generally above the bodies 22 and 24, and nip region 30. A supply conduit (not shown) is affixed to the end of pipe 98 for delivery of liquid coating material into pipe 98 for ultimate delivery through outlet 100.

### Operation

The coating apparatus 20 can be used in a variety of contexts for coating of substrates, such as fertilizers, sands, seeds, or any other particulate material. In one exemplary use illustrated in FIG. 1, the apparatus 20 is positioned above an auger conveyor 102 including an arcuate housing 104 and a conventional auger 106 within housing 104 and serving to convey a particulate substrate S along the length of the housing beneath the assembly 20.

Generally speaking, the operation of apparatus 20 involves rotation of the bodies 22, 24 by activation of drive apparatus 36 in order to rotate the bodies 22, 24 in opposite rotational directions, respectively; the rotational speeds can vary widely, e.g., from about 40-800 rpm, more preferably from about 150-400 rpm. As depicted, the body 22 would rotate in a clockwise direction, whereas body 24 would be rotated counter-clockwise. During such rotation, liquid coating material is delivered through pipe 98 and outlet elbow 100 generally into the nip region 30. As the bodies 22, 24 rotate, liquid coating material is successively picked up by the notches 32 forming the chevron patterns 68 as the notches pass into the nip region 30. After such passage, the liquid-filled notches 32 expel the coating material downwardly and outwardly, creating a diverging flow pattern 108 (see FIGS. 1 and 5).

The desired flow pattern can be adjusted with great accuracy by appropriate modifications of the rotational speed of the bodies 22, 24 and/or the volume of liquid coating material from outlet 100, and/or the chevron patterns 68 of the bodies 22, 24. In practice, it has been found that these modifications will result in virtually no “backsplash” of coating material upwardly or laterally, thus minimizing any tendency to foul the apparatus 20. However, if, desired, a covering shroud (not shown) may be installed above the bodies 22, 24 with a through-aperture permitting passage of the liquid coating material from the outlet 100 onto the rotating bodies 22, 24.

The coating apparatus 20 illustrated herein is susceptible to a number of modifications and alterations, without departing from the spirit and scope of the invention. For example, the number of plates 46 can be varied as needed in order to achieve the desired spray or fog pattern required for a particular coating application. In like manner, the orientations of the chevron patterns 68 may be changed by appropriate relative positioning of the plates 46. As illustrated in FIG. 10, the center lines 70a and 70b of the diverging legs 70 define an included angle θ. This included angle can vary through a wide range, e.g., from about 20-70°.

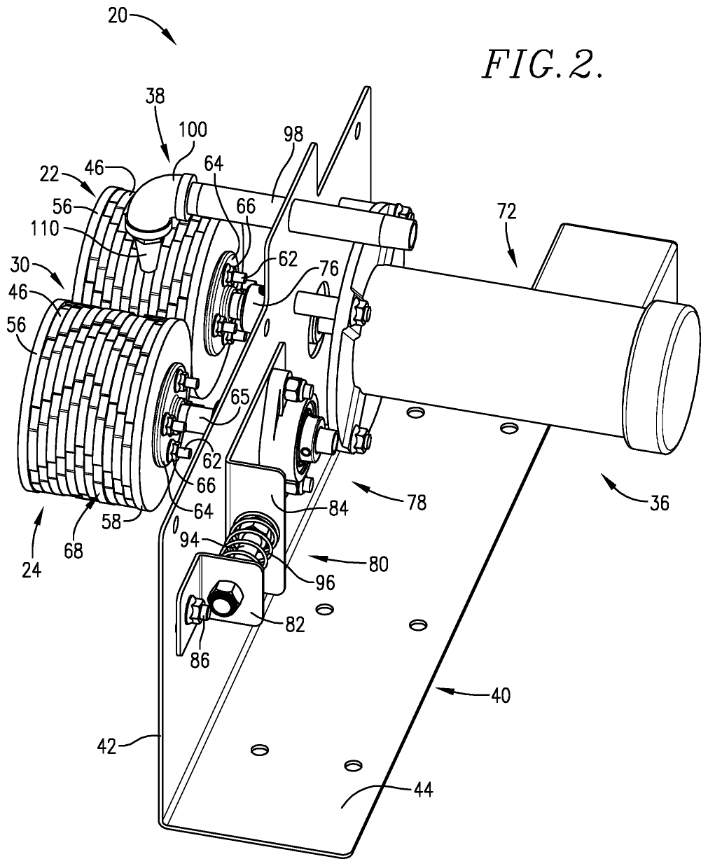

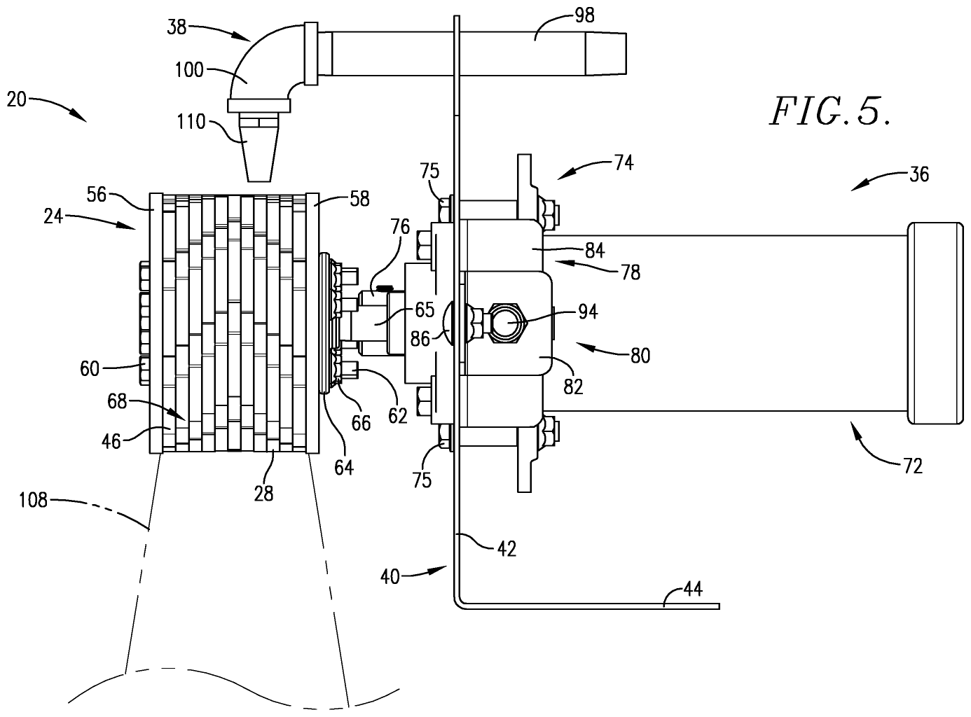

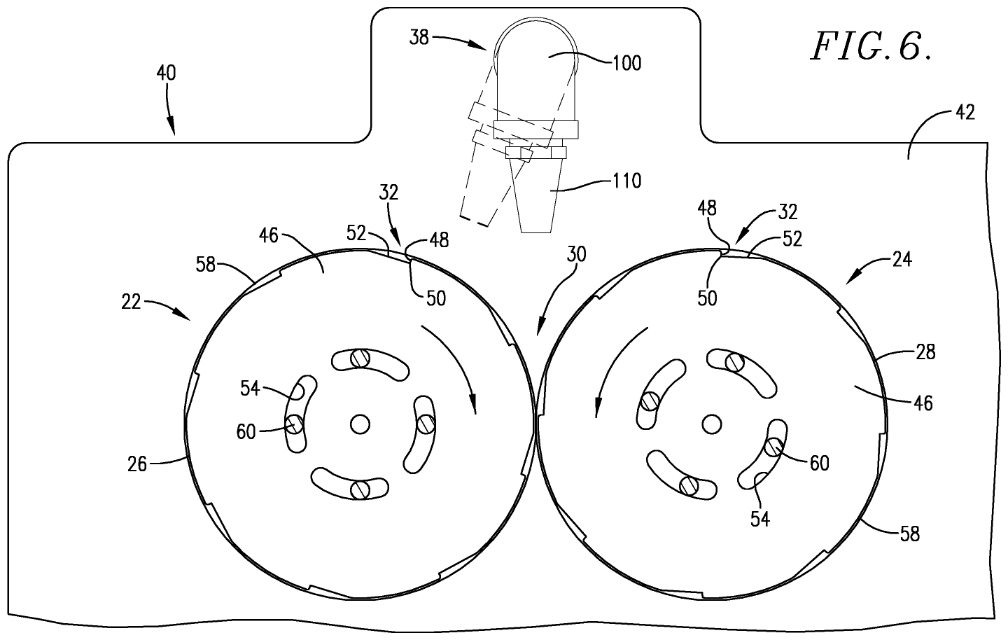

Also, while a simple elbow has been shown as the outlet 100, a restricted orifice nozzle 110 may be used in lieu thereof (see FIGS. 2, and 4-6). Any such outlet may also be rotated from a position directly above the nip region 30 to further alter the delivery pattern of the coating material (see FIG. 6).

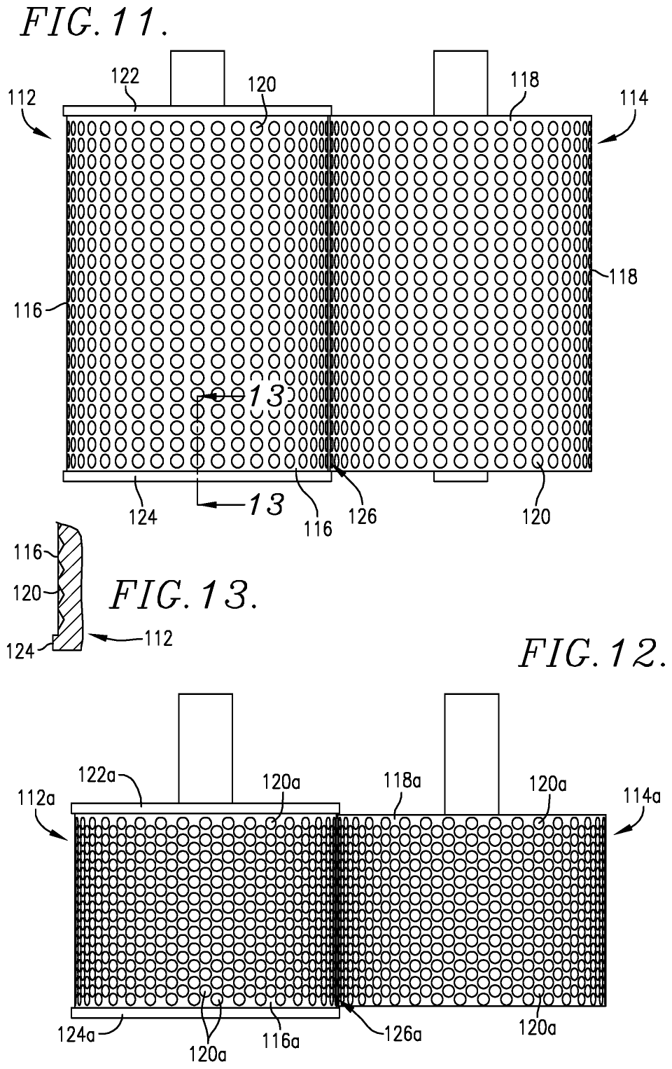

### Embodiments of FIGS. 11-13

FIGS. 11-13 illustrate alternative rollers or bodies 112, 114, which can be used in lieu of the bodies 22, 24 of the first embodiment. In this instance, the bodies 112, 114 are formed of solid Delrin or other synthetic resin material and have peripheries 116, 118, and a series of circular in plan configuration indentations 120 formed in such peripheries. As depicted in FIG. 13, the indentations 120 are in the form of conical depressions, although such is not required. The indentations 120 are provided in circumferential rows which are in alignment as illustrated in FIG. 11. The body 112 is positively driven by a motor or the like, and is equipped with endmost, radially outwardly projecting end sections 122, 124. As illustrated, the peripheries 116, 118 are in close frictional proximity to define a nip region 126, and the end sections 122, 124 prevent misalignment of the bodies during rotation thereof. The body 114 is driven by virtue of the close frictional contact with the body 112, assisted by the passage of liquid coating material into the nip region FIG. 12 depicts similar bodies 112a, 114a with peripheries 116a, 118a, circular indentations 120a, and a cooperatively defined nip region 126a. The body 112a also has radially enlarged end sections 122a and 124a, which again serve to maintain the proper positioning between the bodies 112a, 114a during rotation thereof. However, in this embodiment, the indentations 120a are patterned differently than those depicted in FIGS. 11 and 13, i.e., the indentations are more densely provided in the peripheries 116a, 118a and the indentations within each circumferential row are separated a greater distance. Again, the body 112a is driven, whereas the body 114a rotates by virtue of the frictional engagement between the bodies, assisted by the through-passage of coating material.

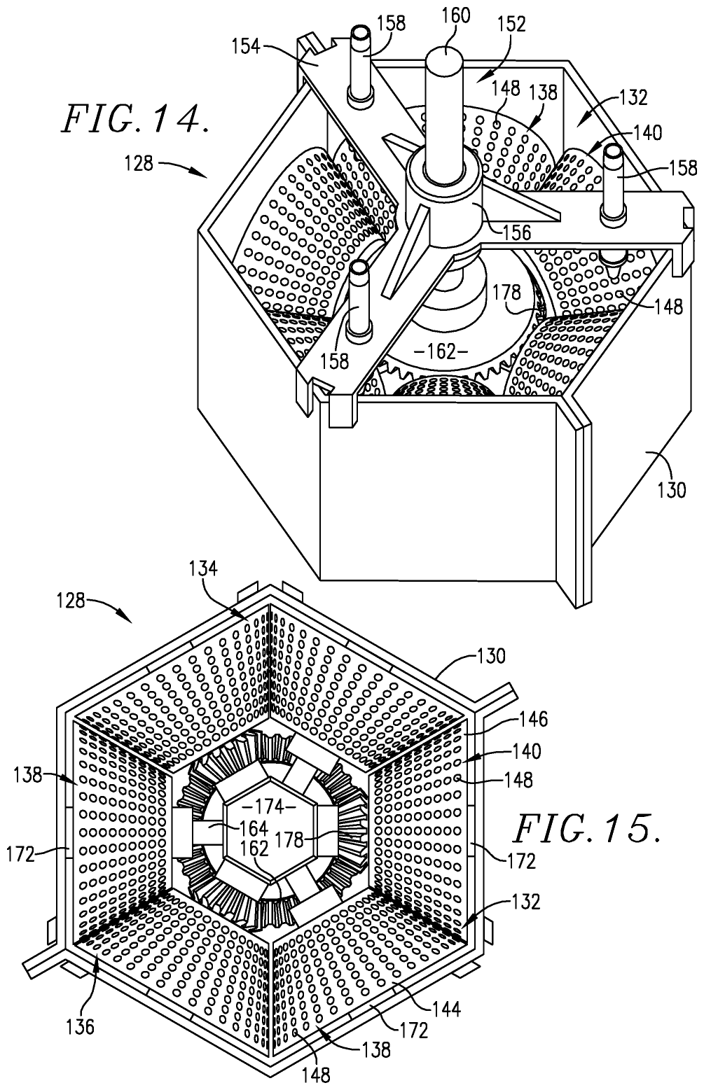

### Embodiment of FIGS. 14-17

FIGS. 14-17 illustrate another type of coating apparatus 128 having a hexagonal housing 130 with three identical pairs of 132, 134, and 136 of roller bodies within the housing 130. The respective pairs 132, 134, 136 are separated by elongated clearance slots 137 to prevent interaction between the pairs.

Inasmuch as each of the pairs is identical, only one need be described in detail. Considering the roller pair 132, it will be seen that it has two frustoconical, frictionally engaged, axially rotatable roller bodies 138 and 140 oriented so that the smaller diameter ends 142 and larger diameter ends 143 are respectively adjacent each other. The peripheral surfaces 144 and 146 have rows of spaced apart, circular in plan configuration indentations 148 therein, which are identical in configuration with the previously described indentations 120. As illustrated the peripheries 144 and 146 are in close, frictional contact and define a nip region 150.

The rollers 138, 140 of each roller pair are supported for rotation by a central assembly 152 generally including a Y-shaped support element 154 secured to housing 130 and presenting a central collar 156. The element 154 also has coating material applicators 158 positioned above the respective nip regions 150. An elongated, rotatable drive shaft 160 (powered by a drive motor, not shown) extends downwardly through collar 156 and supports, adjacent the lower end thereof, a bevel gear 162.

The rollers 138, 140 are each supported for rotation on respective stationary shafts 164 and 166. These shafts extend through hollow bores 168 and 170 provided through the roller bodies 138, 140 and are secured to the inner surface of housing 130 via connection blocks 172. The inboard ends of the shafts 164, 166 are connected to a stationary block 174. Bearing structures 176 are located within the bores 168, 170 and support the individual rollers 138, 140 for rotation about the shafts 164, 166. Respective bevel gears 178 are secured to the inner ends of the bodies 140 and mesh with bevel gear 162. Hence, rotation of drive shaft 160 and bevel gear 162 effects corresponding rotation of the roller bodies 140 relative to the support shafts 166. As explained previously, counter-rotation of the bodies 138 occurs by virtue of the frictional engagement between the bodies 138, 140 at the nip regions 150.

As is evident from the foregoing description, liquid coating material is directed through the applicators 158 during counter-rotation of the rollers 138, 140, and is expelled downwardly at the nip regions 126 in order to coat a substrate. Use of the frustoconical roller bodes 138, 140 provides an enhanced coating pattern, as compared with the cylindrical bodies described above. Moreover, while in the illustrated embodiment three roller pairs 134-136 are illustrated, it will be understood that one or two such roller pairs may be used, and many other modifications may be made in accordance with the scope of the present invention.

As noted previously, the roller bodies may be designed and operated sot that the peripheral indentations of one body fully mates with the indentations on the opposing, second body, i.e., the indentations come into full indentation-to-indentation registry during operation. However, this condition is not essential to operability, and the indentations of one body need not fully mate or register with indentions on the opposing body.

I claim:

1. Coating apparatus comprising:
a pair of juxtaposed bodies each presenting a peripheral surface and oriented to cooperatively define a nip region between said peripheral surfaces,
each of said peripheral surfaces equipped with a series of spaced apart indentations;
apparatus for rotating said bodies in opposite rotational directions, respectively; and
structure for delivery of a coating liquid towards said juxtaposed bodies for passage through said nip region from one side of the bodies during rotation thereof, such that said coating liquid is ejected from the nip region after passage therethrough in a direction away from the bodies.

2. The apparatus of claim 1, said indentations being substantially circular in plan configuration.

3. The apparatus of claim 2, said indentations located in respective rows extending between the ends of said bodies.

4. The apparatus of claim 1, said bodies being substantially cylindrical.

5. The apparatus of claim 1, said bodies being substantially frustoconical, with the smaller diameter end of the bodies being adjacent each other.

6. The apparatus of claim 1, said rotating apparatus comprising a motor operatively secured to said one of said bodies, the bodies being in substantially frictional engagement so that the driven rotation of said one body effects counter-rotation of the other body.

7. The apparatus of claim 1, said rotating apparatus comprising a variable speed motor.

8. The apparatus of claim 1, said coating liquid being ejected in a diverging pattern from said nip region.

9. The apparatus of claim 1, said delivery structure comprising an outlet pipe proximal to said bodies.

10. The apparatus of claim 9, said outlet pipe being rotationally adjustable.

11. The apparatus of claim 1, said rotating apparatus operable to rotate said bodies at a speed of from about 40-800 rpm.

12. The apparatus of claim 1, said delivery structure located above said bodies and nip region.

13. A method of applying a liquid coating material onto a substrate, comprising the steps of:
directing a stream of said liquid coating material into and through a nip region defined by a pair of cylindrical, juxtaposed bodies each presenting a peripheral surface;
rotating said cylindrical bodies in opposite rotational directions, respectively,
the peripheries of said cylindrical bodies equipped with a series of laterally extending indentations; and
causing said bodies, and the indentations in the peripheries thereof, to expel said liquid coating material from said nip region and onto said substrate.

14. The method of claim 13, said indentations being substantially circular in plan configuration.

15. The method of claim 13 said indentations located in respective rows extending between the ends of said bodies.

16. The method of claim 13, said bodies being substantially cylindrical.

17. The method of claim 13, said bodies being substantially frustoconical, with the smaller diameter end of the bodies being adjacent each other.

18. The method of claim 13, said rotating apparatus comprising a motor operatively secured to said one of said bodies, the bodies being in frictional engagement so that the driven rotation of said one body effects counter-rotation of the other body.

19. The method of claim 13, said rotating apparatus comprising a variable speed motor.

20. The method of claim 13, said coating liquid being ejected in a diverging pattern from said nip region.

21. The method of claim 13, said delivery structure comprising an outlet pipe proximal to said bodies.

22. The method of claim 21, said outlet pipe being rotationally adjustable.

23. The method of claim 13, including the step of rotating said bodies at a speed of from about 40-800 rpm.

24. The method of claim 13, said delivery structure located above said bodies and nip region.

25. Coating apparatus comprising:
a housing;
at least one coating apparatus within said housing and including—
a pair of juxtaposed bodies each presenting a peripheral surface and oriented to cooperatively define a nip region between said peripheral surfaces,
each of said peripheral surfaces equipped with a series of spaced apart indentations;
apparatus for rotating said bodies in opposite rotational directions, respectively; and
structure for delivery of a coating liquid towards said juxtaposed bodies for passage through said nip region from one side of the bodies during rotation thereof, such that said coating liquid is ejected from the nip region after passage therethrough in a direction away from the bodies.

26. The coating apparatus of claim 25, there being a plurality of said coating apparatus within said housing.

27. The coating apparatus of claim 25, said bodies being of substantially frustoconical configuration.

28. The coating apparatus of claim 25, said rotating apparatus comprising a drive assembly operably coupled to one of said bodies, the bodies being in substantially frictional engagement so that rotation of the one body serves to drive the other body.

29. The coating apparatus of claim 25, said indentations being substantially circular in plan configuration.

30. The coating apparatus of claim 25, said rotating apparatus operable to rotate said bodies at a speed of from about 40-800 rpm.
